(19) United States
(12) Patent Application Publication
(10) Pub. No.: US 2021/0362633 A1
(43) Pub. Date: Nov. 25, 2021

(54) VEHICLE SEAT COMPRISING A FORCE RECOVERY SYSTEM IN THE EVENT OF A COLLISION

(71) Applicant: Faurecia Sièges d'Automobile, Nanterre (FR)

(72) Inventors: Roland FAURE, ÉTAMPES (FR); Semir HAMMADI, SAULX LES CHARTREUX (FR); Fabrice CAMUS, PARAY VIEILLE POSTE (FR)

(21) Appl. No.: 17/325,822

(22) Filed: May 20, 2021

(30) Foreign Application Priority Data
May 20, 2020 (FR) FR 20 05204

(51) Int. Cl. B60N 2/42; B60N 2/16; B60R 22/26

(52) U.S. Cl. CPC B60N 2/43; B60R 22/26; B60N 2/1685

(57) ABSTRACT

A vehicle seat having a seat cushion and a sliding rail, the seat cushion being movable in an elevation direction. The seat includes an anchoring element and a holding device, with the holding device having a cam and a blocking element. The blocking element is mounted so as to be movable at least in rotation between a nominal position and a blocking position so as to prevent the movement of the seat cushion. The cam is mounted so as to be movable between a rest position and an active position in which it drives the blocking element toward its blocking position. The cam is configured to be moved to the active position when a force greater than a predetermined force is applied to the anchoring element.

### TECHNICAL FIELD

The present invention relates to a vehicle seat of the type comprising a seat cushion, a sliding rail being connected to the seat cushion and being further intended to be connected to a floor of the vehicle and an anchoring element for anchoring a safety belt in the seat cushion.

### BACKGROUND

In a vehicle seat, for example a motor vehicle, it is known to provide an adjustment device for adjusting the position of the seat cushion, in particular an adjustment of the height of the seat cushion or an adjustment of the inclination of the seat cushion, in order to adapt it to the preferences of a seat occupant.

However, in the event of a vehicle impact, the acceleration force acting on the seat occupant is transmitted via the seat belt to the seat cushion in the form of a tensile force on the anchoring element. The tensile force is then transmitted to the adjustment device, which can lead to unintentional actuation of the adjustment device or damage thereof, or even breakage. This has the effect of loosening the seat cushion and causing the position of the seat to be disturbed, sometimes abruptly. This can lead to injury to the seat occupant and to the non-optimal operation of safety devices, such as an airbag, due to the change in the seat occupant's position.

### SUMMARY

One object of the invention is to provide a vehicle seat wherein the holding in position of the seat is improved, particularly in the event of an impact.

To this end, the invention relates to a vehicle seat comprising a seat cushion and a sliding rail, the sliding rail being connected to the seat cushion and being further intended to be connected to a floor of the vehicle, the seat cushion being movable in an elevation direction relative to the sliding rail,
the seat further comprising an anchoring element for anchoring a safety belt in the seat cushion and a holding device for holding the seat cushion in the elevation direction,
the holding device comprising a cam, an blocking element for blocking the position of the seat cushion with respect to the sliding rail and a friction element fixed to the seat cushion,
the blocking element being mounted so as to be movable at least in rotation about a first axis of rotation between a nominal position in which the blocking element is at a distance from the friction element and a blocking position in which the blocking element interacts with the friction element so as to prevent the movement of the seat cushion along the elevation direction,
the cam resting on the blocking element and being mounted so as to be movable on the seat cushion between a rest position in which the blocking element is in its nominal position and an active position in which the cam causes the blocking element to move towards its blocking position,
the cam being configured to be moved to the active position when a force greater than a predetermined force is applied to the anchoring element.

Thus, in the event of an impact causing a force greater than a predetermined force to be applied to the anchoring element, the holding device improves the holding of the seat and allows the tensile force to be transmitted, for example, to the sliding rail and/or the vehicle floor through the sliding rail, thereby avoiding unintentional actuation or damage to the adjustment device.

According to various embodiments of the invention, the seat may include one or more of the following features considered alone or according to all technically possible combinations:
the blocking element is mounted so as to be movable at least in rotation about the first axis of rotation on the sliding rail, the sliding rail comprising a fixed part fixed to the floor and a movable part connected to the seat cushion, the blocking element being mounted on the movable portion,
the holding device further comprises a first return element of the blocking element configured to cause the blocking element to move towards its nominal position when no force greater than a predetermined force is applied to the anchoring element,
the first return element is attached to the sliding rail and applies a return torque to a lower end of the blocking element, the torque being intended for moving the blocking element towards its nominal position,
the cam rests on an upper portion of the blocking element and slides on the blocking element when the seat cushion is moved along the elevation direction,
the cam is mounted so as to be movable rotatably on the seat cushion about a second axis of rotation, the anchoring element being attached to the cam at an attachment point spaced from the second axis of rotation,
the seat comprises a second return element configured to cause the cam to move towards its rest position when no force greater than a predetermined force is applied to the anchoring element,
the blocking element comprises a first toothed surface and the friction element comprises a second toothed surface complementary to the first toothed surface, and optionally, the first toothed surface and the second toothed surface interacting with each other to block relative movement of the blocking element with respect to the friction element when the blocking element is in the blocking position,
the friction element comprises a friction brake pad and the blocking element comprises a friction surface, and optionally, the friction brake pad and the friction surface interacting with each other to block relative movement of the blocking element with respect to the friction element when the blocking element is in the blocking position,
the first return element and the second return element are torsion springs,
the blocking element comprises a first support surface interacting with the friction element when the blocking element is in its blocking position and a second support surface opposite the first support surface and on which the cam is resting.

### BRIEF DESCRIPTION OF THE DRAWINGS

Other aspects and advantages of the invention will become apparent from the following description, given by way of example and made with reference to the attached drawings, in which:

FIG. 1 is a schematic side view representation of a seat portion with the blocking element in the blocking position, and

FIG. 2 is a schematic side view representation of a seat portion according to an embodiment of the invention, with the blocking element in the nominal position.

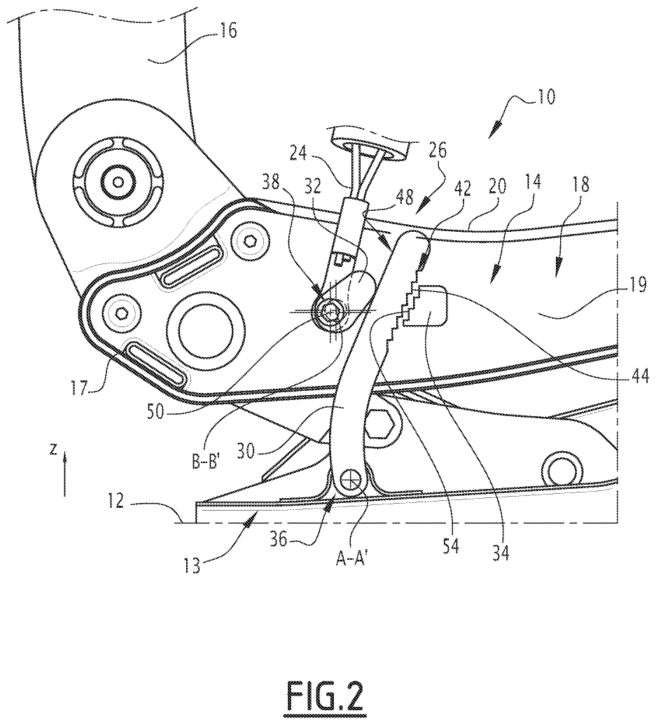

### DETAILED DESCRIPTION

In the following, the elevation direction Z is defined according to the height of a vehicle. This elevation direction Z is, for example, vertical when the vehicle is resting on horizontal ground. The terms “upper” and “lower” are defined for the seat in a situation of normal use of the seat in a vehicle and with respect to the usual directions of a vehicle.

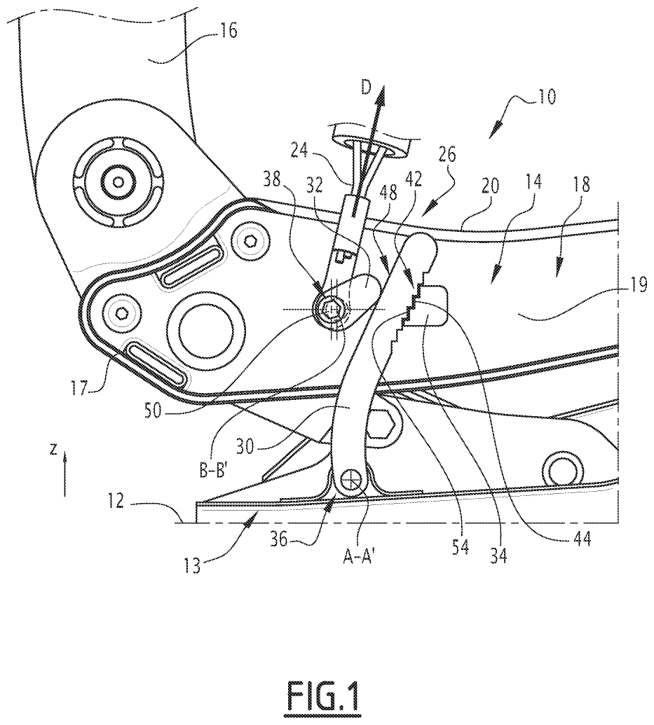

With reference to FIG. 1, a vehicle seat 10 is described.

The vehicle is, for example, a motor vehicle comprising a floor 12.

The seat 10 comprises a seat cushion 14, a sliding rail 13 and a backrest 16 rotatably mounted on the seat cushion 14. The sliding rail 13 is connected to the seat cushion 14 and is further intended to be connected to the floor 12. “Connected” means that the sliding rail 13 is fixed to the seat cushion 14 and to the floor 12 by a fixing system. The fixing system is, for example, a screw-nut type system.

In particular, the sliding rail 13 comprises a fixed portion fixed to the floor 12 of the vehicle and a movable portion connected to the seat cushion 14, the movable part being mounted so as to be movable in translation on the fixed portion. The seat cushion 14 is mounted so as to be movable in translation on the sliding rail 13. “The seat cushion is mounted so as to be movable in translation on the sliding rail” means that the seat cushion 14 is mounted so as to be movable in translation on the fixed portion of the sliding rail 13 via the movable portion of the sliding rail 13. The movable portion is, in general, a male portion of the sliding rail 13 and the fixed portion is, in general, a female portion of the sliding rail 13.

The backrest 16 is a conventional seat backrest and will not be described further.

The seat cushion 14 comprises a frame 17 receiving a cushion 18.

The frame 17 comprises at least two flanks 19 extending on either side of the cushion 18 on the sides of the seat cushion 14 in a horizontal direction perpendicular to the elevation direction Z.

The seat cushion 14 further comprises a reception surface 20 intended to receive a passenger.

The seat cushion 14 is movable in an elevation direction Z of the vehicle by means of a seat position adjustment device (not shown) that can be operated by a user to adapt the height of the seat cushion 14, for example, with respect to the floor 12 of the vehicle. The adjustment device assists in keeping the seat cushion 14 on the floor 12, for example, and/or the sliding rail 13.

The seat 10 further comprises at least one seat belt anchoring element 24 for anchoring a seat belt in the seat cushion 14 and a holding device 26 for holding the seat cushion 14.

The anchoring element 24 is connected to the seat cushion 14 and constitutes an anchoring point of a buckle of the seat belt. In particular, the anchoring element 24 is connected to one of the flanks 19 of the seat cushion 14 and extends along this flank 19.

During an impact on the vehicle, a passenger seated in the seat 10 is, for example, accelerated in an acceleration direction D. The passenger applies a tensile force to the anchoring element 24 via the seat belt in the direction of acceleration D.

During an impact, the anchoring element 24 is intended to transmit the tensile force to the seat cushion 14.

In the event of an impact, the holding device 26 of the seat cushion 14 is intended to take up part of the effort generated by the tensile force even if the device for adjusting the position of the seat cushion 14 is unintentionally actuated or damaged. In this way, the holding device 26 prevents the adjustment device from becoming damaged and no longer able to perform its function of holding the seat cushion 14 on the floor 12 and/or on the sliding rail 13.

The holding device 26 comprises a blocking element 30 for blocking the seat cushion 14 with respect to the floor 12 or the sliding rail 13, a cam 32, a friction element 34 connected to the seat cushion 14. According to one embodiment, the holding device 26 further comprises a first return element 36 and a second return element 38.

The blocking element 30 extends from the floor 12 or sliding rail 13 towards the seat cushion 14 between the cam 32 and the friction element 34.

The blocking element 30 is mounted so as to be movable at least in rotation on the floor 12 or the sliding rail 13 about a first rotation axis A-A′ between a nominal position in which the blocking element 30 is at a distance from the friction element 34 and a blocking position in which a first support surface 42 of the blocking element 30 interacts with the friction element 34 so as to prevent the movement of the seat cushion 14 along the elevation direction Z.

Furthermore, an assembly comprising the seat 10 and the floor 12 is defined, the blocking element 30 being mounted on the floor 12 and/or the sliding rail 13.

The blocking element 30 may be mounted only rotatably about the first rotation axis A-A′ between the nominal position and the blocking position.

The blocking element 30 is, for example, mounted so as to be movable at least in rotation about the first rotation axis A-A′ on the fixed portion or on the movable portion of the sliding rail 13. Preferably, the blocking element 30 is mounted so as to be movable at least in rotation on the movable portion of the sliding rail 13. The blocking element 30 can also be mounted on any fixed element of the vehicle external to the seat 10 or the floor 12.

For example, the blocking element 30 extends along a flank 19 of the seat cushion 14 in the same plane of extension as that of the anchoring element 24.

The first support surface 42 comprises a first toothed surface 44 intended to interact with the friction element 34 in the blocking position of the blocking element 30.

The cam 32 rests on a second support surface 48 of the blocking element 30 and drives the blocking element 30 in rotation about the first axis of rotation A-A′.

The cam 32 has, for example, an ovoid outer profile resting on the second support surface 48.

The second support surface 48 is located on an upper portion of the blocking element 30.

In particular, the cam 32 is mounted so as to be movable rotatably on the seat cushion 14 about a second axis of rotation B-B′ between a rest position in which the blocking element 30 is in its nominal position and an active position in which the cam 32 causes the blocking element 30 to move towards its blocking position.

The anchoring element 24 is attached to the cam 32 at an attachment point 50 spaced from the second axis of rotation B-B′. Thus, an eccentricity of the attachment point 50 with respect to the second axis of rotation B-B′ can be defined. This eccentricity is the radial distance with respect to the axis of rotation B-B′ separating the attachment point 50 from the second axis of rotation B-B′.

During an impact on the vehicle, when an impact force greater than a predetermined force is applied to the anchoring element 24, the anchoring element 24 is moved relative to the seat cushion 14 along the direction of acceleration D and causes the cam 32 to rotate so that the cam 32 is moved to the active position.

The ovoid outer profile of the cam 32 then allows the rotational movement of the cam 32 to be translated into a translational movement of the blocking element 30 towards the front of the seat 10 and thus to a rotation of the blocking element 30 about the axis A-A′ toward the blocking position of the blocking element 30.

The predetermined force is, for example, between 100 N and 400 N, in particular equal to 250 N. The predetermined force is, for example, equal to 250 N.

When the seat cushion 14 is moved along the elevation direction Z during normal use of the seat, the cam 32 slides on the blocking element 30 and does not cause it to move to the active position so that the seat 14 position adjustment device can be used without hindrance.

The friction element 34 extends, for example, along the flank 19 of the seat cushion 14 in the same plane of extension as that of the anchoring element 24, the blocking element 30 and the cam 32.

The friction element 34 comprises a second toothed surface 54 complementary to the first toothed surface 44.

The first toothed surface 44 and the second toothed surface 54 comprise a plurality of teeth protruding from the blocking element 30 and the friction element 34, respectively.

The teeth have, for example, a height of between 1 mm and 5 mm, in particular equal to 2.5 mm. The height is, for example, equal to 2.5 mm. The height of a tooth is defined as the distance between a base of the tooth from which it extends and the free end of the tooth.

The teeth are, for example, spaced at a distance of between 1 mm and 10 mm, in particular equal to 4 mm. The distance is, for example, 4 mm. The distance is taken along the first toothed surface 44 and the second toothed surface 54.

The second toothed surface 54 is intended to interact with the first toothed surface 44 to block the relative movement of the blocking element 30 with respect to the friction element 34 when the blocking element 30 is in the blocking position.

The first toothed surface 44 and the second toothed surface 54 extend over the first support surface 42 and the friction element 34, respectively, over a sufficiently large distance so that the second toothed surface 54 can interact with the first toothed surface 44 in the blocking position regardless of the movement of the seat cushion 14 relative to the floor 12 and/or the sliding rail 13.

The first return element 36 is a return element for returning the blocking element 30, attached to the floor 12 or the sliding rail 13 and configured to cause the blocking element 30 to move to its nominal position when no impact force is applied to the anchoring element 24.

The first return element 36 is configured to apply a first return torque to a lower end of the blocking element 30, the first return torque being intended to cause the blocking element 30 to move toward its nominal position.

The first return element 36 is, for example, a torsion spring.

The first return element 36 thus ensures that the blocking element 30 is always in contact with the cam 32 at the second support surface 48.

The second return element 38 is a return element for returning the cam 32, attached to the anchoring element 24 and configured to cause the cam 32 to move toward its rest position.

The second return element 38 applies a second return torque to the cam 32.

The second return element 38 is, for example, a torsion spring.

The second return element 38 opposes the tensile force on the anchoring element 24 along the direction D. The holding system 26 comprises an internal stop (not shown) limiting the rotation of the cam 32 when no tensile force is applied to the anchoring element 24 and the cam 32 reaches its rest position.

The predetermined force defining the impact force depends on the second return torque as well as the eccentricity of the attachment point 50 with respect to the second axis of rotation B-B′.

After a first impact on the vehicle, when the impact force is no longer applied to the anchoring element 24, the second return element 38 causes the cam 32 to move towards its rest position and the first return element 36 causes the blocking element 30 to move towards its nominal position.

After this first impact, the seat cushion 14 can then be freely moved again in the elevation direction Z.

However, the holding device 26 is still able to hold the seat cushion 14 in the elevation direction Z relative to the floor 12 and/or the sliding rail 13 if a second impact occurs.

In other words, the holding device 26 is not degraded during an impact and is reusable without the need to change its constituent parts.

According to one variant of embodiment described, the second return element 38 is configured to drive the movement of the cam 32 towards its active position. According to this variant, the second return torque is then less than the first return torque applied by the first return element 36 on the blocking element 30 so that the cam 32 is permanently in contact with the second support surface 48 of the blocking element. The first and second return torques are then set so that the predetermined force defining the impact force is equal to the subtraction of the first return torque by the second return torque. Thus, after a first impact to the vehicle, when the impact force is no longer applied to the anchoring element 24, the first return element 36 causes the blocking element 30 to move to its nominal position and causes the cam 32 to move towards its rest position.

According to another variant of the described embodiment, the first support surface 42 comprises a friction surface for interacting with the friction element 34 in the blocking position.

According to this variant, the friction element 34 comprises a friction brake pad.

The friction brake pad of the friction element 34 and the friction surface of the blocking element 30 interact with each other to block relative movement of the blocking element 30 with respect to the friction element 34 when the blocking element 30 is in the blocking position.

In the blocking position, the friction surface of the blocking element 30 is applied against the friction element 34 so as to generate between them a frictional force opposing movement of the blocking element 30 and the friction element 34 relative to each other. Such a frictional force is, for example, due to the nature of the material or materials chosen to make the frictional surface of the blocking element 30 and/or the frictional element 34.

Since the blocking element 30 is connected to the floor 12 and/or the sliding rail 13 and the friction element 34 is connected to the seat cushion 14, the holding device 26 opposes a movement of the seat cushion 14 and the floor 12 or the sliding rail 13 relative to each other in the blocking position.

The seat 10 makes it possible to reinforce the holding in position of the seat cushion 14 on the floor 12 and/or the sliding rail 13 particularly in the event of an impact on the vehicle. In particular, the seat 10 allows the energy of the impact to be transmitted to the floor 12 and/or the sliding rail 13 not via the height adjustment device of the seat cushion 14 but via the holding device 26 dedicated to this task.

Thus, the integrity of the adjustment device is ensured.

1. A vehicle seat comprising a seat cushion and a sliding rail, the sliding rail being connected to the seat cushion and being further intended to be connected to a floor of the vehicle, the seat cushion being movable in an elevation direction relative to the sliding rail,
the seat further comprising an anchoring element for anchoring a safety belt in the seat cushion and a holding device for holding the seat cushion in the elevation direction,
the holding device comprising a cam, a blocking element for blocking the position of the seat cushion with respect to the sliding rail, and a friction element fixed to the seat cushion,
the blocking element being mounted so as to be movable at least in rotation about a first axis of rotation between a nominal position in which the blocking element is at a distance from the friction element and a blocking position in which the blocking element interacts with the friction element so as to prevent the movement of the seat cushion along the elevation direction,
the cam resting on the blocking element and being mounted so as to be movable on the seat cushion between a rest position in which the blocking element is in its nominal position and an active position in which the cam causes the blocking element to move towards its blocking position,
the cam being configured to be moved to the active position when a force greater than a predetermined force is applied to the anchoring element.

2. The seat according to claim 1, wherein the blocking element is mounted so as to be movable at least in rotation about the first axis of rotation on the sliding rail, the sliding rail comprising a fixed portion fixed to the floor and a movable portion connected to the seat, the blocking element being mounted on the movable portion.

3. The seat according to claim 1, wherein the holding device further comprises a first return element of the blocking element configured to cause the blocking element to move toward its nominal position when no force greater than a predetermined force is applied to the anchoring element.

4. The seat according to claim 1, wherein the first return element is attached to the sliding rail and applies a return torque to a lower end of the blocking element, the torque being intended for moving the blocking element towards its nominal position.

5. The seat according to claim 1, wherein the cam rests on an upper portion of the blocking element and slides on the blocking element when the seat cushion is moved along the elevation direction.

6. The seat according to claim 1, wherein the cam is mounted so as to be movable rotatably on the seat cushion about a second axis of rotation, the anchoring element being attached to the cam at an attachment point spaced from the second axis of rotation.

7. The seat according to claim 1, comprising a second return element configured to cause the cam to move towards its rest position when no force greater than a predetermined force is applied to the anchoring element.

8. The seat according to claim 7, wherein the first return element and the second return element are torsion springs.

9. The seat according to claim 1, wherein the blocking element comprises a first toothed surface and the friction element comprises a second toothed surface complementary to the first toothed surface,
the first toothed surface and the second toothed surface interacting with each other to block relative movement of the blocking element with respect to the friction element when the blocking element is in the blocking position.

10. The seat according to claim 1, wherein the friction element comprises a friction brake pad and the blocking element comprises a friction surface,
the friction brake pad and the friction surface interacting with each other to block relative movement of the blocking element with respect to the friction element when the blocking element is in the blocking position.

11. A seat according to claim 1, wherein the blocking element comprises a first support surface interacting with the friction element when the blocking element is in its blocking position and a second support surface opposite the first support surface and on which the cam is resting.
